(19) United States
(12) Patent Application Publication
(10) Pub. No.: US 2010/0089266 A1
(43) Pub. Date: Apr. 15, 2010

(54) Broadsheet Newspaper and Method

(75) Inventor: John Sheridan Richards, Barrington, NH (US)

Correspondence Address: Davidson, Davidson & Kappel, LLC, 485 7th Avenue, 14th Floor, New York, NY, 10018, US

(73) Assignee: Goss International Americas, Inc., Durham, NH (US)

(21) Appl. No.: 12/435,810

(22) Filed: May 5, 2009

Related U.S. Application Data
(60) Provisional application No. 61/135,705, filed on Jul. 23, 2008.
(60) Provisional application No. 61/126,434, filed on May 5, 2008.

(51) Int. Cl. B41F 13/56; B42D 15/00; B41F 33/00

(52) U.S. Cl. 101/227; 283/117; 101/483

(57) ABSTRACT

A method for making a broadsheet newspaper is provided. The method includes the steps of printing an image on a web, longitudinally folding the web to form a half-fold, cross-cutting the web to form signatures and cross-folding the signatures at a height of 33% or less or 67% or more.

A further preferred method for making a broadsheet newspaper is provided. The method includes the steps of printing an image on a web, longitudinally folding the web to form a half-fold, cross-cutting the web to form signatures and cross-folding the signatures at a height 10.5 inches or more from an edge of the newspaper.

Broadsheet newspapers are also provided. A printing press is also provided.

This claims priority to U.S. Provisional Application No. 61/135,705 filed on Jul. 23, 2008 and U.S. Provisional Application No. 61/126,434 filed on May 5, 2008, the entire disclosures of which are hereby incorporated by reference herein.

### BACKGROUND OF THE INVENTION

The present invention relates generally to newspapers, newspaper printing presses and folders, and to a broadsheet newspaper.

U.S. Pat. No. 6,935,234 discloses a newspaper printing press and is hereby incorporated by reference herein described below.

U.S. Patent Application Publication No. 2007/0261576 purportedly discloses an upright arrangement of tabloid pages on a form cylinder so the back of the tabloid book to be produced is formed via the folding funnel during longitudinal folding. A transverse fold is no longer required. The tabloid books are obtained through transverse cutting and a former fold.

U.S. Pat. Nos. 6,367,792, 6,688,224, 6,733,431 and 6,752,751 disclose folders, and are hereby incorporated by reference herein. U.S. Pat. No. 6,082,724 discloses an inserter for placing inserts in a newspaper jacket.

An unfolded Berliner or midi format newspaper normally measures about 470 mm (18.5 inches) in height and 315 mm (12.0 to 12.5 inches) in width. Several European newspapers, including Le Monde, La Vanguardia, and La Repubblica use this format. The Berliner or midi format is generally cross-folded in addition to being longitudinally folded on the former as opposed to tabloids which are not folded on the former. The cross-fold is generally at the midpoint of the height, i.e. at 235 mm.

### BRIEF SUMMARY OF THE INVENTION

The present invention provides a broadsheet newspaper comprising printed material, the newspaper having a height of approximately 14.67 inches and a cross fold at approximately 4.17 inches.

The present invention provides a broadsheet newspaper. The broadsheet newspaper includes printed material longitudinally folded to form a broadsheet newspaper and a cross-fold located at 33% a height of the broadsheet newspaper or less.

The present invention also provides a further broadsheet newspaper. The further broadsheet newspaper includes printed material longitudinally folded to form a broadsheet newspaper and a cross-fold located 10.5 inches or more from an edge of the broadsheet newspaper. The cross-fold is perpendicular to the longitudinal fold and the cross-fold defines a face and a flap. The face has a height of 10.5 inches or more and the flap has a height of less than 10.5 inches.

The present invention also provides a method for making a broadsheet newspaper. The method includes the steps of printing an image on a web, longitudinally folding the web to form a half-fold, cross-cutting the web to form signatures and cross-folding the signatures at a height of 33% or less or 67% or more.

The present invention also provides a further method for making a broadsheet newspaper. The method includes the steps of printing an image on a web, longitudinally folding the web to form a half-fold, cross-cutting the web to form signatures and cross-folding the signatures at a height at a height 10.5 inches or more from an edge of the newspaper.

The present invention further provides a printing press. The printing press includes at least one printing unit printing on a web, a former for longitudinally folding the web, a cross cutter for cutting the longitudinally folded web into newspapers and folding cylinders for cross-folding the newspapers. The cross-fold is located 10.5 inches or more from an edge of the broadsheet newspaper and the cross-fold is perpendicular to the longitudinal fold. The cross-fold defines a face and a flap, the face has a height of 10.5 inches or more. A height of the flap is less than a height of the face.

By having the cross-fold off-center at this distance, variable format broadsheet newspapers with a longer side may be created which permit inserts even with smaller sized broadsheet newspapers.

In a preferred embodiment, the broadsheet newspaper has a height of about 14.67 inches, and the distance between a pin edge of the product and tucker blade is approximately 4.17 inches or less and the distance between the tucker blade and the non-pin edge of the product is 10.5 inches or more. This provides a newspaper having a 10.5-inch face and a 4.17-inch flap. Thus, the 10.5-inch face allows standard 10.5-inch inserts to be inserted into the newspaper without sticking out.

The present invention also provides a broadsheet newspaper having a height of approximately 14.67 inches and a cross-fold at approximately 4.17 inches.

### BRIEF DESCRIPTION OF THE DRAWINGS

A preferred embodiment of the present invention is described below by reference to the following drawings, in which:

FIG. 1 shows a perspective view of a broadsheet newspaper according to the present invention;

FIG. 2 shows a front view of the broadsheet newspaper shown in FIG. 1;

FIG. 3 shows a front view of the broadsheet newspaper shown in FIG. 2 folded;

FIG. 4 shows a back view of the folded broadsheet newspaper shown in FIG. 3 including inserts;

FIG. 5 shows a perspective view of the broadsheet newspaper shown in FIG. 1 including a plurality of sections;

FIG. 6 shows the broadsheet newspaper shown in FIG. 1 open at the cross-fold and half-fold; and

FIG. 7 shows schematically a broadsheet newspaper printing press according to the present invention.

### DETAILED DESCRIPTION OF A PREFERRED EMBODIMENT

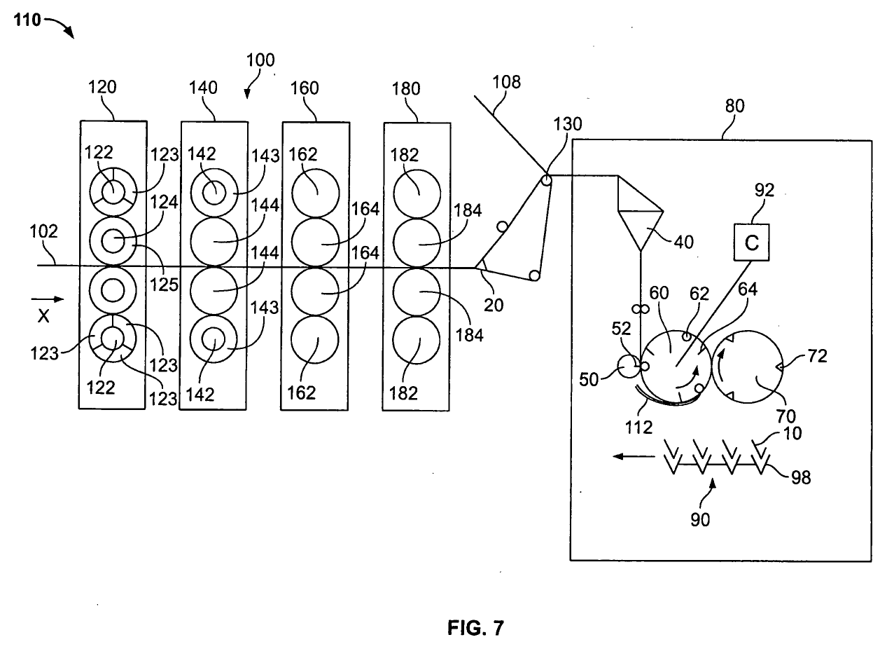

FIG. 7 shows a broadsheet newspaper printing press 110 having a printing section 100 which may be for example, an offset, perfecting, lithographic web printing section printing in a plurality of colors, for example, cyan, magenta, yellow and black. Each printing unit 120, 140, 160, 180 may print a different color on a web 102. Each printing unit 120, 140, 160, 180 may have corresponding plate cylinders 122, 142, 162, 182 carrying printing plates, for example, printing plates 123, 143 on plate cylinders 122, 142 respectively. Plate cylinders 142 may be a one around plate cylinder and printing plates 143 may have a 44-inch circumference. In another preferred embodiment, plate cylinders 122 carry three images via printing plates 123. Web 102 may be 48 inches wide.

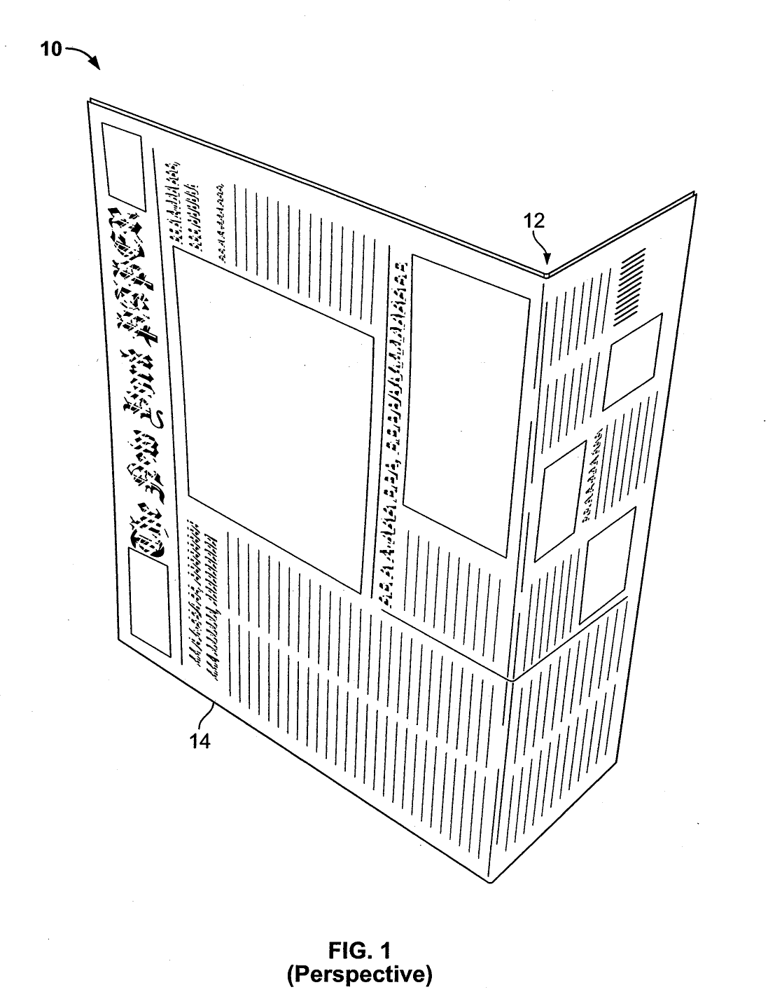

Web 102 travels from printing section 100 to a folder 80 in a direction X. Web 102 may be slit by a slitter 20 into ribbons which are recombined, potentially with other ribbons 108, at a roller 130. Ribbons of web 102 then enter folder 80 and pass to a former board 40 for longitudinal folding. The ribbons are folded in half longitudinally, in the direction of travel. (See half fold 14 in FIGS. 1 to 3). A cross cutter 50 including a knife blade 52 cuts ribbons into broadsheet newspapers 112, which are gripped at a lead edge by a gripper 62 on a tucker cylinder 60. Grippers 62 may be, for example, pins or a hold-down device for pinless gripping. Cross cutter 50 rotates clockwise, tucking cylinder 60 rotates counter-clockwise and a jaw cylinder 70 rotates clockwise. A tucking blade 64 on tucking cylinder 60 tucks a gripped newspaper 112 into a jaw 72 of jaw cylinder 70 forming a cross fold 12 in newspaper 112 and forming a broadsheet newspaper 10. (See cross fold 12 in FIGS. 1 to 3).

In a preferred embodiment, newspaper 112 is cut by cross cutter 50 to have a total height of, for example, about 14.67 inches. Since a front face section is desired having a length of, preferably, 10.5 inch, the distance between a gripper 62 and gripped edge 15 (See FIG. 2) of newspaper 112 and tucker blade 64 is approximately 4.17 inches or less so the distance between tucker blade 64 and a non-pin edge 11 (See FIG. 2) is 10.5 inches or more.

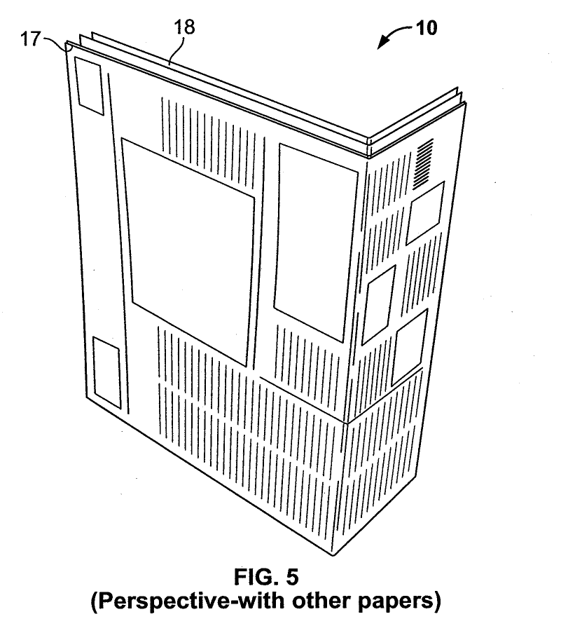

Broadsheet newspapers 10 are removed from jaw cylinder 70 and transported downstream to, for example, a fan wheel, a belt conveyor, a gripper pick-up, and then delivered to a pocket conveyor 90 including a plurality of pockets 98, only the pocket conveyor 90 being shown here for simplicity. The fan wheel and belt conveyor are shown for example in U.S. Pat. No. 6,733,341, hereby incorporated by reference herein. Broadsheet newspapers 10 may also be delivered to a quarterfolder for further folding. Inserts 20 (FIG. 4) may be placed into newspapers 10 downstream by, for example, a hopper mechanism.

A controller 92 can set the phasing between the grippers 62 and tuckers 64 of tucking cylinder 60, and control the phasing of jaws 72 of jaw cylinder 70, so that a cross-fold distance can be set. Owing to the phasing control, the cross-fold can be set at 33% or less or 67% or more of the height of the newspaper. This offset advantageously can permit smaller format newspapers to receive standard inserts for example by providing a newspaper with a longer side or face and a shorter flap. Providing the longer side or face may advantageously help retain the appearance of a traditional newspaper and includes protection for standard sized inserts inserted downstream. Moreover, folder spiders may also provide phasing for the grippers 62, tucking blades 64 and jaws 71.

FIG. 1 shows a perspective view of a broadsheet newspaper 10 having cross-fold 12 and longitudinal half-fold 14 printed and folded on printing press 110.

FIG. 2 shows a front view of broadsheet newspaper 10. Newspaper 10 has a height H₀ and a width W₁ when newspaper 10 is half-folded, but not cross-folded. Height H₀ may be, for example, 14.67 inches and width W₁ may be, for example, 12.0 inches. The width may also be, for example, between 10.0 and 20 inches. Height H₀ includes a height H₁ above cross-fold 12 and height H₂ below cross-fold 12. Height H₁ may be, for example, 10.5 inches, or 71.6% of newspaper height H₀. Height H₂ may be, for example, 4.17 inches or 28.4% of newspaper height H₀. In additional preferred embodiments, height H₁ may be 67% or more of newspaper height H₀ and the height H₂ below cross fold may be 33% or less or vice versa, height H₁ may be 33% or less and height H₂ may be 67% or more.

An edge 15 may be, for example, the pinned or gripped lead edge. Edge 15 may be gripped by a folding cylinder so cross-fold 12 may be formed. An edge 14 is the longitudinal half-folded edge, and an edge 13 is the edge opposite the longitudinally folded edge 14. Edge 11 may be an ungripped edge opposite gripped edge 15.

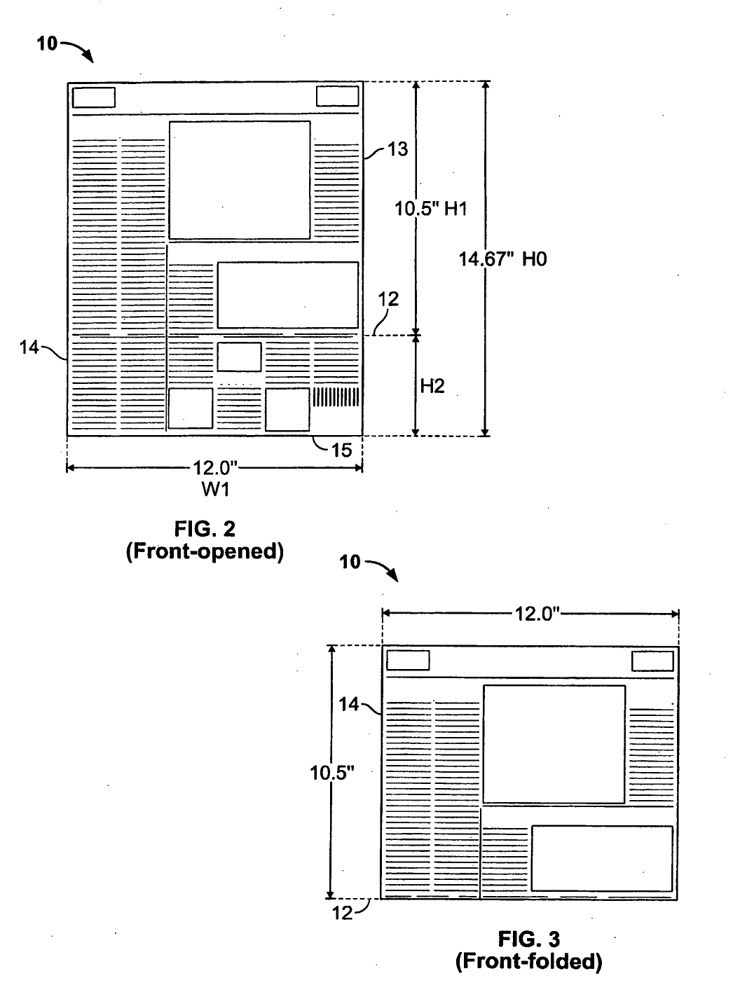

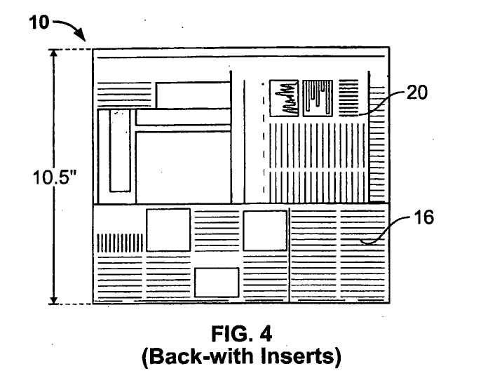

FIG. 3 shows a front view of newspaper 10 folded at cross-fold 12. Height H₂ of newspaper 10 has been folded behind height H₁ of newspaper 10 forming a flap.

FIG. 4 shows a back view of newspaper 10 including a plurality of inserts 20. Inserts 20 may be placed inside flap 16. Inserts 20 may be standard sized inserts, for example, 10.5 inches in height and be equal to height H₁ of newspaper 10. Inserts 20 may also be a combination of sizes. Inserts may be fed from a hopper. Thus, a broadsheet newspaper with 10.5-inch inserts 20 can be formed using a broadsheet newspaper having a shorter overall height, for example, 14.67 inches.

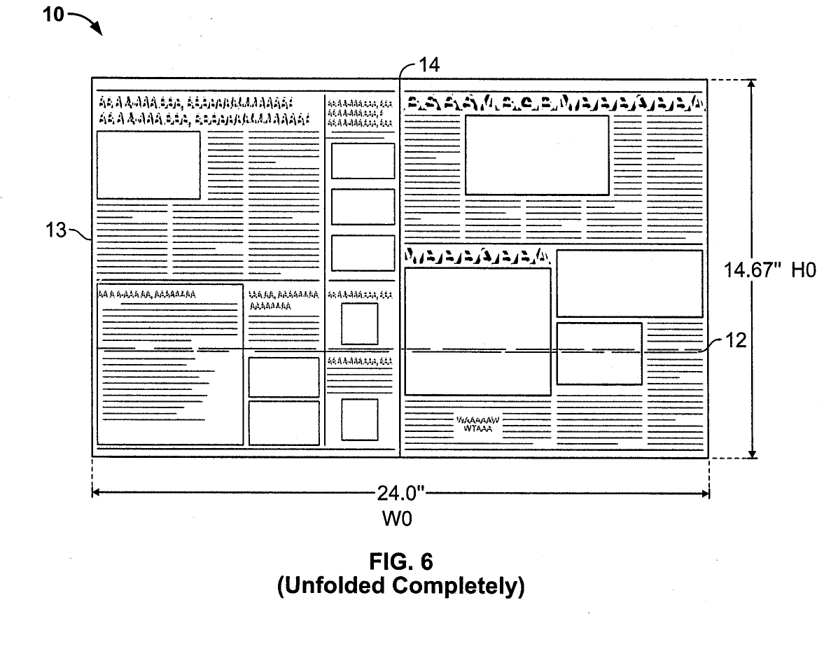

As shown in FIG. 5, newspaper 10 may include multiple sections 17, 18. Each section may be based on a desired layout of newspaper 10. For example, section 17 may include news and section 18 may include sports. Each section 17, 18 may include a plurality of pages or sheets. A plurality of sections may be included in newspaper 10. Sections may include, for example, entertainment, science, financial, world events, local events, etc.

Newspaper 10 may be completely unfolded as shown in FIG. 6. When unfolded at half-fold 14, newspaper 10 as an entire width W₀. Entire width may be W₀, for example, 24.0 inches. Half-fold 14 may be located in a middle of entire width W₀, for example, at 24.0 inches from an edge 13 of newspaper 10. Thus, when folded at half-fold 14, newspaper 10 has a width W₁ of, for example, 12 inches, as shown in FIG. 2.

Advantageously, a 48-inch wide web can be printed on a printing press 110 and slit into two 24-inch wide web ribbons. The broadsheet newspaper maybe pinned along edge 15 and cut so as to have a height of 14.67 inches. The tucking cylinder 60 and jaw cylinder 70 may also be designed to run in collect mode in which newspapers are gathered on tucking cylinder 60 before being tucked and folded into jaw 72.

Furthermore, an existing two-around plate cylinder or dual lockup plate cylinder having a 44-inch circumference may be retrofit to print newspaper 10. The plate lockup located at 180° may be filled or removed and a single plate 143 containing three images may be mounted on plate cylinders 142 to print three images each having a height of 14.67 inches on web 102.

As defined herein, the cross-fold can be in either direction so that 33% or less covers 67% or more. Thus, newspaper 112 may be arranged so tucking blade 64 and grippers 62 are oriented with respect to either edge 15 or edge 11.

What is claimed is:

1. A method for making a broadsheet newspaper comprising the steps of:
printing an image on a web;
longitudinally folding the web to form a half-fold;
cross-cutting the web to form signatures; and
cross-folding the signatures at a height of 33% or less or 67% or more.

2. The method as recited in claim 1 wherein the cross-fold is located at 28.4% of the height.

3. The method as recited in claim 1 wherein the cross-fold is located at 71.6% of the height.

4. A method for making a broadsheet newspaper comprising the steps of:
printing an image on a web;
longitudinally folding the web to form a half-fold;
cross-cutting the web to form signatures; and
cross-folding the signatures at a height 10.5 inches or more from an edge of the newspaper.

5. The method as recited in claim 4 wherein the cross-fold defines a face and a flap, the face having a height of 10.5 inches or more, a height of the flap being less than a height of the face.

6. The method as recited in claim 4 wherein the flap has a height of 4.17 inches.

7. A printing press comprising:
at least one printing unit printing on a web;
a former for longitudinally folding the web;
a cross cutter for cutting the longitudinally folded web into newspapers; and
folding cylinders for cross-folding the newspapers, the cross-fold being located 10.5 inches or more from an edge of the broadsheet newspaper, the cross-fold being perpendicular to the longitudinal fold, the cross-fold defining a face and a flap, the face having a height of 10.5 inches or more, a height of the flap being less than a height of the face.

8. A broadsheet newspaper comprising:
printed material longitudinally folded to form a broadsheet newspaper; and
a cross-fold located at 33% or less a height of the broadsheet newspaper.

9. The broadsheet newspaper as recited in claim 8 wherein the broadsheet newspaper has a total height of approximately 14.67 inches and a cross fold at approximately 4.17 inches.

10. The broadsheet newspaper as recited in claim 8 wherein the cross-fold is located at 28.4% of the height of the newspaper.

11. A broadsheet newspaper comprising:
printed material longitudinally folded to form a broadsheet newspaper; and
a cross-fold located 10.5 inches or more from an edge of the broadsheet newspaper, the cross-fold being perpendicular to the longitudinal fold, the cross-fold defining a face and a flap, the face having a height of 10.5 inches or more, a height of the flap being less than a height of the face.

12. The broadsheet newspaper as recited in claim 1 wherein the flap has a height of 4.17 inches.
